(19) United States
(12) Patent Application Publication
(10) Pub. No.: US 2010/0244696 A1
(43) Pub. Date: Sep. 30, 2010

(54) Apparatus for Connecting LED Lamps Into Lighting Instruments of a Fluorescent Lamp

(76) Inventor: Chul Kim, Gyeonggi-do (KR)

Correspondence Address: FLASTER/GREENBERG P.C.;Four Penn Center, 1600 John F. Kennedy Boulevard, 2nd Floor, PHILADELPHIA, PA, 19103, US

(21) Appl. No.: 12/742,900

(22) PCT Filed: Nov. 11, 2008
(86) PCT No.: PCT/KR08/06632

§ 371 Date: May 13, 2010

(30) Foreign Application Priority Data
Nov. 13, 2007 (KR) 10-2007-0115518

(51) Int. Cl. F21V 23/00

(52) U.S. Cl. 315/51

(57) ABSTRACT

Disclosed herein is an apparatus for connecting Light-Emitting Diode (LED) lamps to a fluorescent lamp apparatus. The fluorescent lamp apparatus is provided with a fluorescent lamp mounting unit having an Alternating Current (AC) power supply unit, a ballast, two connection terminals on the first side thereof and two connection terminals on the second side thereof. The apparatus of the present invention includes a bridge diode for full-wave-rectifying AC current conducted between a first-side connecting terminal connected to the AC power supply unit and a second-side connection terminal connected to the ballast, a smoothing capacitor for smoothing the power full-wave-rectified by the bridge diode and outputting Direct Current (DC) power, and an LED lamp power supply unit for converting the smoothed DC power into LED lamp driving power and outputting the LED lamp driving power to the LED lamps.

### BACKGROUND OF THE INVENTION

1. Field of the Invention

The present invention relates to an apparatus for connecting Light-Emitting Diode (LED) lamps to a fluorescent lamp apparatus

2. Description of Related Art

Fluorescent lamps are lighting devices that are most widely used today along with incandescent lamps because the fluorescent lamps can achieve economical and high illuminance in buildings, factories, homes and the like.

A fluorescent lamp apparatus includes an ignition circuit for lighting a fluorescent lamp first and a ballast for maintaining the lighting of the fluorescent lamp after the lighting of the fluorescent lamp. The ignition circuit is formed of a high voltage generation circuit for generating electric discharge in a fluorescent lamp first, and a ballast having a negative resistance characteristic for maintaining the lighting of a discharge tube after the lighting of the discharge tube is used as the ballast.

Such fluorescent lamp apparatuses are basically classified into two types, that is, a magnetic type and an electronic high frequency type. Magnetic-type fluorescent lamps use current limiting inductors, and are classified into a glow starter type and a rapid starter type depending on the ignition methods thereof. Electronic high frequency-type fluorescent lamps convert commercial power into DC and apply high frequency power to fluorescent lamps through high frequency resonance circuits, and are classified into a current mode type and a voltage mode type.

FIG. 1 is a diagram showing a conventional magnetic glow starter-type fluorescent lamp apparatus. This magnetic glow starter-type fluorescent lamp apparatus includes an Alternating Current (AC) power supply unit 11, a glow starter 12, a ballast 13, and a fluorescent lamp mounting unit. The fluorescent lamp mounting unit includes two connection terminals a1 and a2, or b1 and b2 on each of the two sides thereof. A fluorescent lamp FL is mounted on the fluorescent lamp mounting unit in such a way that two terminals on each of the two sides of the fluorescent lamp FL are respectively connected to the two connection terminals a1 and a2, or b1 and b2 on each of the two sides of the fluorescent lamp mounting unit.

When AC power is applied through the AC power supply unit 11, power is applied to the glow starter 12, and thus the glow starter 12 is heated. Meanwhile, the internal bimetal strip of the heated glow starter 12 is extended, so that the glow starter 12 is short-circuited. When the glow starter 12 is short-circuited, current is supplied to the ballast 13 and the filaments of the fluorescent lamp, and heat is reduced because the glow starter 12 is short-circuited. When the bimetal strip is shrunken due to the cooling of the glow starter 12, the glow starter 12 is opened. When the glow starter 12 is opened, high voltage is induced to the inductor of the ballast 13. The induced high voltage is applied to both ends of the fluorescent lamp, and thus the fluorescent lamp FL is ignited. In the ignited fluorescent lamp FL, thermions generated by filaments on both ends of the fluorescent lamp FL form a plasma state, and thus current starts to flow. The ballast 13 performs control so that limiting current flows so as to maintain the plasma state in the fluorescent lamp.

FIG. 2 is a diagram showing a conventional magnetic rapid starter-type fluorescent lamp apparatus. This magnetic rapid starter-type fluorescent lamp apparatus includes an AC power supply unit 21, a ballast 22, and a fluorescent lamp mounting unit. The fluorescent lamp mounting unit includes two connection terminals a1 and a2, or b1 and b2 on each of the two sides thereof. The fluorescent lamp FL is mounted on the fluorescent lamp mounting unit in such a way that two terminals on each side of the fluorescent lamp FL are respectively connected to the two connection terminals a1 and a2, or b1 and b2 on each side of the fluorescent lamp mounting unit.

In this magnetic rapid starter-type fluorescent lamp apparatus, the ballast 22 constantly supplies power to the filaments of the fluorescent lamp FL and supplies high voltage to both end electrodes of the fluorescent lamp, thereby enabling rapid ignition when power is supplied. When lighting is performed, the ballast 23 maintains lighting by limiting current, flowing through the fluorescent lamp, to lighting current.

The electronic high frequency-type fluorescent lamp apparatus converts AC power into DC and applies high-frequency power to the fluorescent lamp through the high frequency resonance circuit, and are classified into a voltage mode type and a current mode type depending on the filament driving methods thereof.

FIG. 3 is a diagram showing a conventional electronic high-frequency voltage mode-type fluorescent lamp apparatus. A fluorescent lamp FL is mounted on a fluorescent lamp mounting unit having two connection terminals on each of the two sides thereof, like that of the magnetic starter-type fluorescent lamp apparatus. In this electronic high frequency voltage mode-type fluorescent lamp apparatus, AC power is rectified into DC through bridge diodes D31, D32, D33 and D34 and a smoothing capacitor C_{REG}, and a control circuit 31 generates high-frequency voltage through half bridge Field Effect Transistors (FETs) FET31 and FET32 using tens of KHz of high frequency signal. This high frequency voltage is supplied to the fluorescent lamp through a resonance coil L_{RES}, a resonance capacitor C_{RES} and a blocking capacitor C_{BLK} in the form of a high frequency signal. Voltage induced by the resonance coil L_{RES} is supplied to the filaments of the fluorescent lamp FL through coupled inductors L_{FIL1} and L_{FIL2}.

FIG. 4 is a diagram showing a conventional electronic high frequency current mode-type fluorescent lamp apparatus. A fluorescent lamp FL is mounted on a fluorescent lamp mounting unit having two connection terminals on each of the two sides thereof, like that of the magnetic starter-type fluorescent lamp apparatus. In this electronic high frequency current mode-type fluorescent lamp apparatus, AC power is rectified into DC through bridge diodes D41, D42, D43 and D44 and smoothing capacitor C_{REG}, and a control circuit 41 generates high frequency voltage through half bridge FETs FET41 and FET42 using a several tens of KHz of high frequency signal. This high frequency voltage is supplied to the fluorescent lamp FL through a blocking capacitor C_{BLK}, the filaments of the fluorescent lamp FL connected to a resonance coil L_{RES}, and a resonance capacitor C_{RES}. Furthermore, current is supplied to the filaments of the fluorescent lamp FL as the resonance current of the resonance coil L_{RES} and the resonance capacitor C_{RES}.

Currently, although most homes generate illumination using fluorescent lamps, the fluorescent lamps have short life spans and low light emission efficiency compared to LED lamps and additionally have the problem of environmental pollution attributable to filled gas, so that it is preferable to replace the fluorescent lamps with LED lamps.

In order to replace a fluorescent lamp with LED lamps, an existing fluorescent lamp apparatus must be replaced with an LED lamp apparatus. In this case, there arise problems in that the cost of the LED lamp apparatus itself is not only high but the cost of replacing the fluorescent lamp apparatus with the LED lamp apparatus is also high.

### BRIEF SUMMARY OF THE INVENTION

Accordingly, the present invention has been made keeping in mind the above problems occurring in the prior art, and an object of the present invention is to provide an apparatus for connecting LED lamps to a fluorescent lamp apparatus that enables LED lamps to be connected to a fluorescent lamp apparatus without requiring the replacement of an existing fluorescent lamp apparatus with an LED lamp apparatus, thereby enabling the replacement of a fluorescent lamp with LED lamps at minimum cost.

In order to accomplish the above object, the present invention provides an apparatus for connecting LED lamps to a fluorescent lamp apparatus provided with a fluorescent lamp mounting unit having an AC power supply unit, a ballast, two connection terminals on the first side thereof and two connection terminals on the second side thereof, the apparatus including a bridge diode for full-wave-rectifying AC current conducted between a first-side connecting terminal connected to the AC power supply unit and a second-side connection terminal connected to the ballast, a smoothing capacitor for smoothing the power full-wave-rectified by the bridge diode and outputting DC power, and an LED lamp power supply unit for converting the smoothed DC power into LED lamp driving power and outputting the LED lamp driving power to the LED lamps.

Furthermore, the present invention provides an apparatus for connecting LED lamps to a fluorescent lamp apparatus provided with a fluorescent lamp mounting unit having an AC power supply unit, a ballast, two connection terminals on the first side thereof and two connection terminals on the second side thereof, the apparatus including two bridge diodes connected to the two connection terminals on the first side of the fluorescent lamp mounting unit and to the two connection terminals on the second side and configured to full-wave-rectify AC power conducted between one arbitrary connection terminal on the first side and one arbitrary connection terminal on the second side, a smoothing capacitor configured to smooth the power full-wave-rectified by the two bridge diodes and output DC power, and an LED lamp power supply unit configured to convert the smoothed DC power into LED lamp driving power and output the LED lamp driving power to the LED lamps.

The present invention enables LED lamps to be connected to a fluorescent lamp apparatus, thereby achieving the advantages of increase in the life span of an illumination lamp, reduction in electricity consumption and environmental friendliness without requiring the replacement of the fluorescent lamp apparatus.

### BRIEF DESCRIPTION OF THE SEVERAL VIEWS OF THE DRAWING(S)

FIG. 1 is a diagram showing a conventional magnetic glow starter type fluorescent lamp apparatus;

FIG. 2 is a diagram showing a conventional magnetic rapid starter type fluorescent lamp apparatus;

FIG. 3 is a diagram showing a conventional electronic high-frequency voltage mode-type fluorescent lamp apparatus;

FIG. 4 is a diagram showing a conventional electronic high frequency current mode-type fluorescent lamp apparatus;

FIG. 5 shows an apparatus for connecting LED lamps to a fluorescent lamp apparatus according to a first embodiment of the present invention, which is an embodiment in which LED lamps are connected to a magnetic glow starter-type fluorescent lamp apparatus;

FIGS. 6 and 7 are diagrams illustrating the problem of the apparatus for connecting LED lamps shown in FIG. 5;

FIG. 8 shows an apparatus for connecting LED lamps to a fluorescent lamp apparatus according to a second embodiment of the present invention in which the problem of the apparatus for connecting LED lamps shown in FIG. 5 has been overcome, which is an embodiment in which LED lamps are connected to a magnetic glow starter-type fluorescent lamp apparatus;

FIG. 9 shows an apparatus for connecting LED lamps to a fluorescent lamp apparatus according to a third embodiment of the present invention in which the problem of the apparatus for connecting LED lamps shown in FIG. 5 has been overcome, which is an embodiment in which LED lamps are connected to a magnetic glow starter-type fluorescent lamp apparatus;

FIG. 10 shows an embodiment in which the apparatus for connecting LED lamps to a fluorescent lamp apparatus according to the second embodiment of the present invention is applied to the magnetic rapid starter-type fluorescent lamp apparatus of FIG. 2;

FIG. 11 shows an embodiment in which the apparatus for connecting LED lamps to a fluorescent lamp apparatus according to the second embodiment of the present invention is applied to the electronic high frequency voltage mode type fluorescent lamp apparatus of FIG. 3; and

FIG. 12 shows an embodiment in which the apparatus for connecting LED lamps to a fluorescent lamp apparatus according to the second embodiment of the present invention is applied to the electronic high frequency current mode-type fluorescent lamp apparatus of FIG. 4.

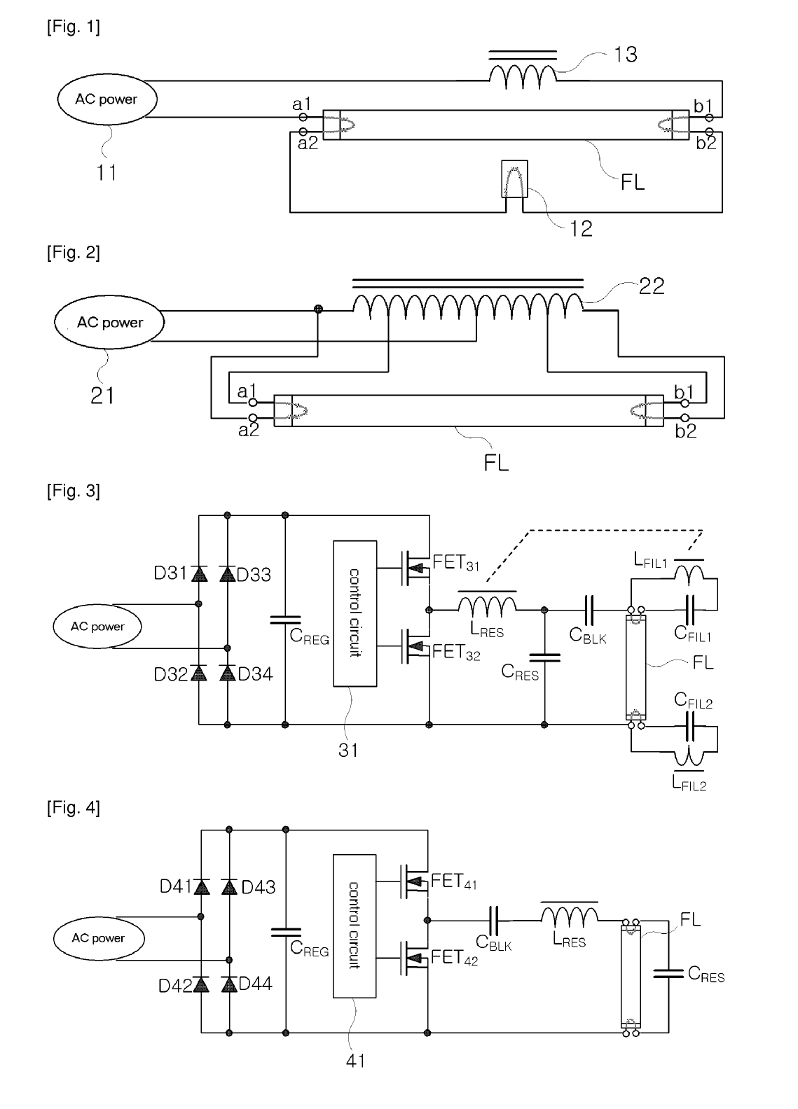

### DETAILED DESCRIPTION OF THE INVENTION

An apparatus for connecting LED lamps to a fluorescent lamp apparatus according to an embodiment of the present invention will be described in detail below.

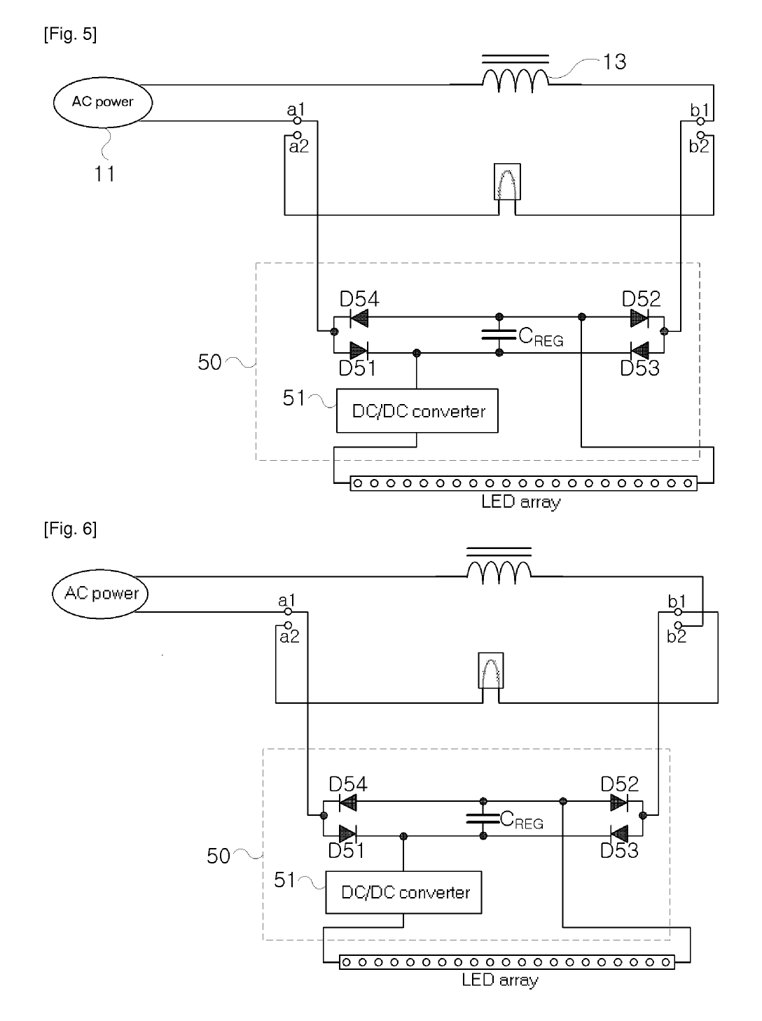

FIG. 5 shows an apparatus 50 for connecting LED lamps to a fluorescent lamp apparatus according to a first embodiment of the present invention, which is an embodiment in which LED lamps are connected to a magnetic glow starter-type fluorescent lamp apparatus.

This apparatus 50 for connecting LED lamps is connected in series to an AC power supply unit 11 and a ballast 13, each of which is connected to one of the two connection terminals on each side of the fluorescent lamp mounting unit of the fluorescent lamp apparatus. In the case where a connection terminal a1 is connected to the AC power supply unit 11 and a connection terminal b1 is connected to the ballast 13, as shown in FIG. 5, this apparatus 50 for connecting LED lamps should be connected between the connection terminal a1 and the connection terminal b1.

The apparatus 50 for connecting LED lamps includes bridge diodes D51, D52, D53 and D54 for rectifying input power, a smoothing capacitor C_{REG} for smoothing power full-wave-rectified through the bridge diodes D51, D52, D53 and D54 and outputting DC power, and an LED lamp power supply unit for converting the smoothed DC power into LED lamp driving power. The output power of the LED lamp power supply unit is supplied to an LED array, and thus the LED lamps are operated. Although a DC/DC converter constant current power circuit 51 is illustrated as the LED lamp power supply unit in the drawing, this LED lamp power supply unit may be also implemented using a series regulator constant current power circuit or a current limiting resistor. In this case, the use of the DC/DC converter constant current power circuit is related to a method for improving the stability of an LED array and energy efficiency, and the use of the series regulator constant current power circuit and the current limiting resistor is related to a method for enabling practical implementation.

The apparatus for connecting LED lamps to a fluorescent lamp apparatus according to the first embodiment of the present invention generates DC power through the diode D51, the smoothing capacitor C_{REG} and the diode D52 during the positive (+) period of the AC power supply unit 11, and generates DC power through the diode D53, the smoothing capacitor C_{REG} and the diode D54 during the negative (−) period. The DC/DC converter constant current power circuit 51 converts the generated DC power into LED lamp driving power and supplies it to the LED array.

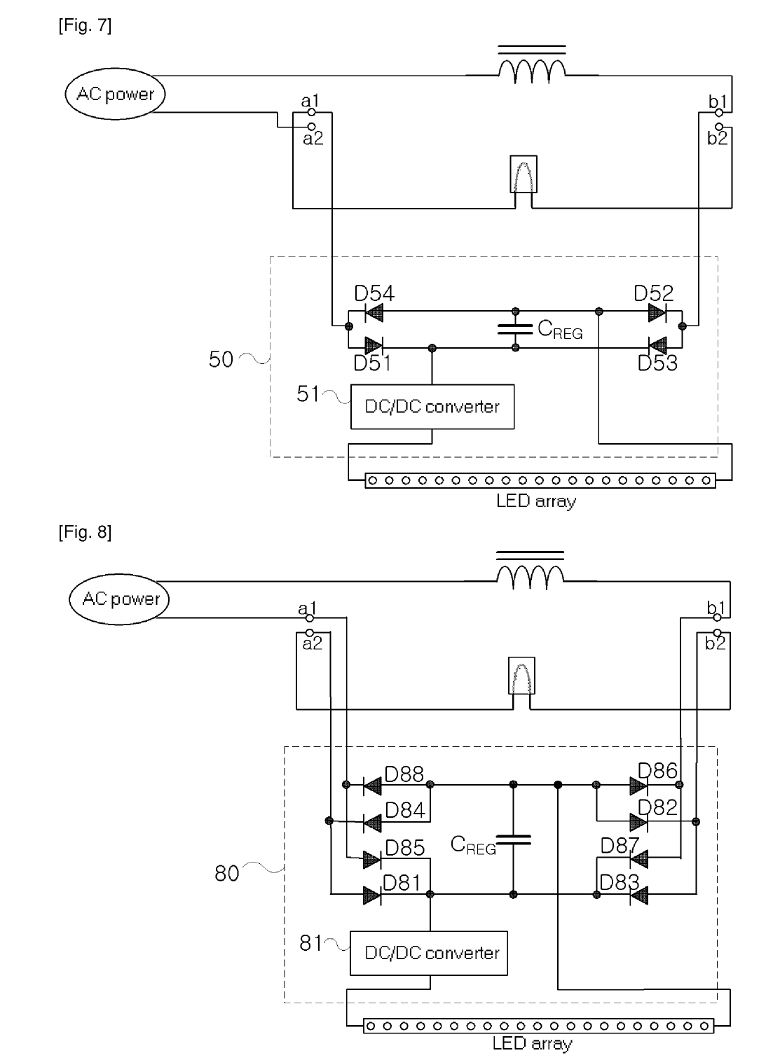

Since the fluorescent lamps have no polarity, the wiring of the apparatus for connecting LED lamps to the fluorescent lamp apparatus may be configured in such a way that a ballast is connected to a connection terminal b2 as shown in FIG. 6 or an AC power supply unit is connected to a connection terminal a2 as shown in FIG. 7. Furthermore, although not shown in the drawings, the ballast may be connected to the connection terminal b2 and the AC power supply unit may be connected to the connection terminal a2. If the apparatus for connecting LED lamps is connected as shown in FIG. 6 or 7, it is impossible for the apparatus for connecting LED lamps to output driving power for the LED lamps. The fluorescent lamp apparatus has a problem in that since it is difficult to know which of two connection terminals on one side of the fluorescent lamp mounting unit is connected to the AC power supply unit and which of two terminals on the other side is connected to the ballast, the connection status of each connection terminal must be found in order to connect the apparatus for connecting LED lamps shown in FIG. 5 to the fluorescent lamp apparatus.

There are four types of wiring for the apparatus for connecting LED lamps to a fluorescent lamp apparatus. Accordingly, a method capable of driving LED lamps regardless of the type of wiring of the apparatus for connecting LED lamps is required.

FIG. 8 shows an apparatus for connecting LED lamps to a fluorescent lamp apparatus according to a second embodiment of the present invention in which the problem of the apparatus for connecting LED lamps shown in FIG. 5 has been overcome, which is an embodiment in which LED lamps are connected to a magnetic glow starter-type fluorescent lamp apparatus. The apparatus for connecting LED lamps includes two bridge diodes D81˜D88 connected to first and second connection terminals on the first side of the fluorescent lamp mounting unit and to third and fourth connection terminals on the second side and configured to full-wave-rectify AC power conducted between one arbitrary connection terminal on the first side and one arbitrary connection terminal on the second side, a smoothing capacitor C_{REG} configured to smooth the full-wave-rectified power, and an LED lamp power supply unit configured to convert the smoothed DC power into LED lamp driving power. The output power of the LED lamp power supply unit is supplied to the LED array, and thus the LED lamps are driven. Although a DC/DC converter constant current power circuit 81 is illustrated as the LED lamp power supply unit, the LED lamp power supply unit may be implemented using a series regulator constant current power circuit or a current limiting resistor. Here, the use of the DC/DC converter constant current power circuit is related to a method for improving the stability of the LED array and energy efficiency, and the use of the series regulator constant current power circuit and the current limiting resistor is related to a method for enabling practical implementation.

In the example of FIG. 8, an AC power supply unit 11 is connected to a connection terminal a1, and a ballast 13 is connected to a connection terminal b1. During the positive (+) period of AC power output through the AC power supply unit 11, DC power is generated through the diode D85, the smoothing capacitor C_{REG} and the diode D86, and during the negative (−) period, DC power is generated through the diode D87, the smoothing capacitor C_{REG} and the diode D88. The DC/DC converter constant current power circuit 81 converts the generated DC power into LED lamp driving power, and supplies it to the LED array.

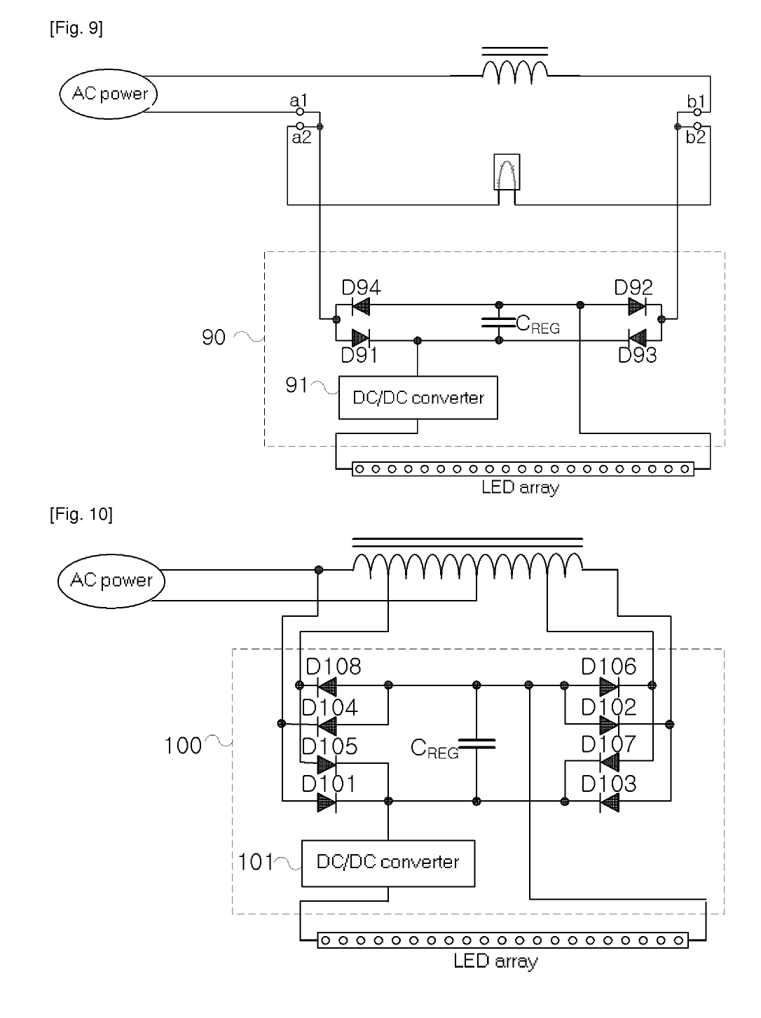

FIG. 9 shows an apparatus for connecting LED lamps to a fluorescent lamp apparatus according to a third embodiment of the present invention in which the problem of the apparatus for connecting LED lamps shown in FIG. 5 has been overcome, which is an embodiment in which LED lamps are connected to a magnetic glow starter-type fluorescent lamp apparatus. The apparatus for connecting LED lamps shown in FIG. 9 electrically connects two side terminals of the fluorescent lamp mounting unit to each other. That is, a terminal a1 and a terminal a2 are connected to each other and then the connected terminals a1 and a2 are connected to the bridge diode D91, D92, D93 and D94 of the apparatus 90 for connecting LED lamps, while a terminal b1 and a terminal b2 are connected to each other and then the connected terminals b1 and b2 are connected to the bridge diode D91, D92, D93 and D94 of the apparatus 90 for connecting LED lamps. Although the apparatus 90 for connecting LED lamps according to the third embodiment has a circuit simpler than that of FIG. 8, the driving voltage for the LED array increases in proportion to the number of series connections between the LEDs of the LED array, and thus there is a possibility of glow starter being operated. In this case, high voltage is induced to two sides of the LED array, which may destroy the LED array. Furthermore, this third embodiment may be applied only to magnetic glow starter-type fluorescent lamps.

FIG. 10 shows an embodiment in which the apparatus for connecting LED lamps to a fluorescent lamp apparatus according to the second embodiment of the present invention is applied to the magnetic rapid starter-type fluorescent lamp apparatus of FIG. 2. The apparatus 100 for connecting LED lamps includes two bridge diodes D101 ˜D108 connected to first and second connection terminals on the first side of a fluorescent lamp mounting unit and to third and fourth connection terminals on the second side thereof and configured to full-wave-rectify AC power conducted between one arbitrary connection terminal on the first side and one arbitrary connection terminal on the second side, a smoothing capacitor C_{REG} for smoothing the full-wave-rectified power, and an LED lamp power supply unit for converting the smoothed DC power into LED lamp driving power. The output power of the LED lamp power supply unit is supplied to the LED array, and thus the LED lamps are driven. Although a DC/DC converter constant current power circuit 101 is illustrated as the LED lamp power supply unit in this drawing, this LED lamp power supply unit may be also implemented using a series regulator constant current power circuit or a current limiting resistor. Here, the use of the DC/DC converter constant current power circuit is related to a method for improving the stability of the LED array and energy efficiency, and the use of the series regulator constant current power circuit and the current limiting resistor is related to a method for enabling practical implementation. The operation of the apparatus for connecting LED lamps to a fluorescent lamp apparatus of FIG. 10 is the same as that of FIG. 8.

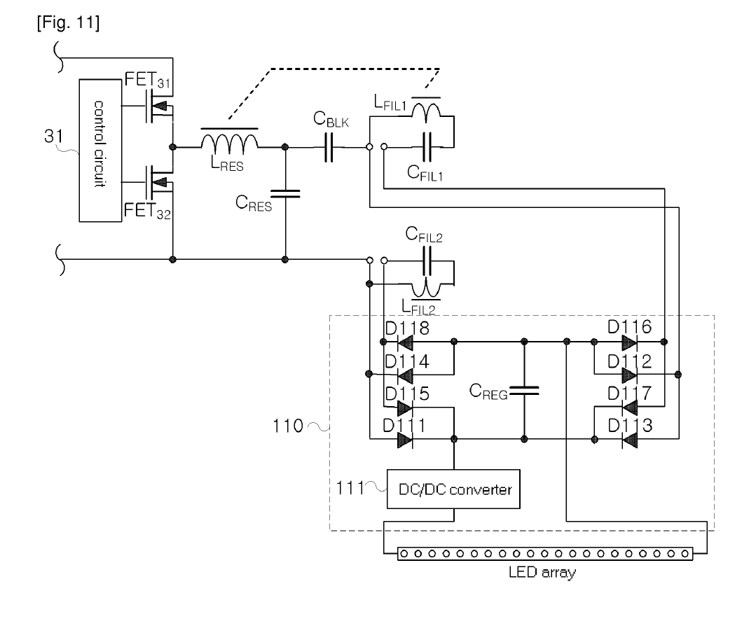

FIG. 11 shows an embodiment in which the apparatus for connecting LED lamps to a fluorescent lamp apparatus according to the second embodiment of the present invention is applied to the electronic high frequency voltage mode type fluorescent lamp apparatus of FIG. 3. An apparatus 110 for connecting LED lamps to a fluorescent lamp apparatus includes two bridge diodes D111 ˜D118, a smoothing capacitor C_{REG}, and an LED lamp power supply unit. Although a DC/DC converter constant current power circuit 111 is illustrated as the LED lamp power supply unit in this drawing, this LED lamp power supply unit may be also implemented using a series regulator constant current power circuit or a current limiting resistor. In a high frequency voltage mode-type method, a high frequency signal is supplied to the bridge diodes D111 ˜D118, so that diodes having a high switching frequency like fast recovery diodes should be used and smoothing capacitors for a high frequency should be used as the smoothing capacitor C_{REG}. The operation of the apparatus for connecting LED lamps shown in FIG. 11 is the same as that of FIG. 8.

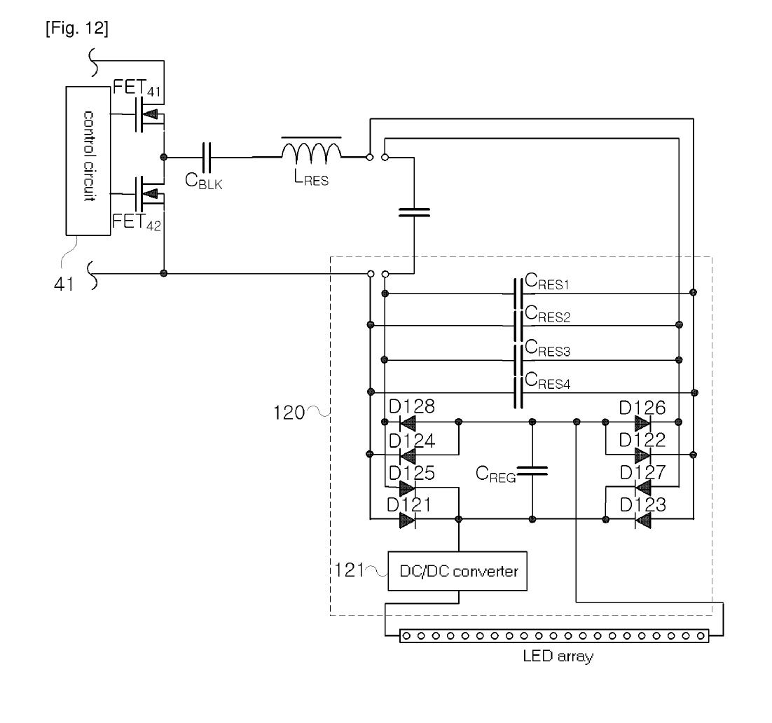

FIG. 12 shows an embodiment in which the apparatus for connecting LED lamps to a fluorescent lamp apparatus according to the second embodiment of the present invention is applied to the electronic high frequency current mode-type fluorescent lamp apparatus of FIG. 4. An apparatus 120 for connecting LED lamps to a fluorescent lamp apparatus includes two bridge diodes D121 ˜D128, a smoothing capacitor C_{REG}, and an LED lamp power supply unit. Although the DC/DC converter constant current power circuit 121 is illustrated as the LED lamp power supply unit in this drawing, this LED lamp power supply unit may be also implemented using a series regulator constant current power circuit or a current limiting resistor. Meanwhile, in order to apply the apparatus for connecting LED lamps to a fluorescent lamp apparatus to the electronic high frequency current mode-type fluorescent lamp apparatus, first to fourth resonance capacitors C_{RES1} to C_{RES4} should be additionally provided between two connection terminals on the first side of the fluorescent lamp mounting unit and two connection terminal on the second side thereof.

By doing so, the apparatus of the present invention can drive the LED lamps because a resonance capacitor is always connected regardless of the direction of the wiring of the apparatus for connecting LED lamps to a fluorescent lamp apparatus. Meanwhile, in a high frequency current mode-type method, a high frequency signal is supplied to the bridge diodes D121 ˜D128, so that diodes having a high switching frequency like fast recovery diodes should be used, and a smoothing capacitor C_{REG} for a high frequency should be used as the smoothing capacitor C_{REG}. The operation of the apparatus for connecting LED lamps to a fluorescent lamp apparatus of FIG. 12 is the same as that of FIG. 8.

Although the technical spirit of the present invention has been described in connection with the accompanying drawings, this illustrates the preferred embodiments of the present invention, but is not intended to limit the present invention. Furthermore, it will be apparent to those having ordinary skill in the related technical field that various modifications and imitations are possible within a range that does not depart form the scope of the technical spirit of the present invention.

The present invention can be used as the technology for lighting LED lamps using existing fluorescent lamp apparatuses.

1. An apparatus for connecting Light-Emitting Diode (LED) lamps to a fluorescent lamp apparatus provided with a fluorescent lamp mounting unit having an Alternating Current (AC) power supply unit, a ballast, and first to fourth connection terminals, wherein one of the first and second connection terminals is connected with the Alternating Current (AC) power supply unit, and one of the third and fourth connection terminals is connected with the ballast, the apparatus comprising:
first to fourth diodes connected to the first to fourth connection terminals respectively at anode terminals thereof and to a first common contact at cathode terminals thereof;
fifth to eighth diodes connected to the first to fourth connection terminals respectively at cathode terminals thereof and to a second common contact at anode terminals thereof;
a smoothing capacitor connected between the first and second common contacts, and configured to smooth Alternating Current (AC) power full-wave-rectified by four of the diodes, wherein two diodes connect to the connection terminal connected with the Alternating Current (AC) power supply and two diodes connect to the connection terminal connected with the ballast, and output Direct Current (DC) power; and
an LED lamp power supply unit configured to convert the smoothed DC power into LED lamp driving power and output the LED lamp driving power to the LED lamps.

2. The apparatus set forth in claim 1, wherein the first to eighth diodes are fast recovery diodes.

3. The apparatus set forth in claim 1, wherein the smoothing capacitor is a capacitor for a high frequency.

4. The apparatus set forth in claim 1, further comprising a first resonance capacitor configured to connect the first connection terminal with the third connection terminal, a second resonance capacitor configured to connect the first connection terminal with the fourth connection terminal, a third resonance capacitor configured to connect the second connection terminal with the third connection terminal, and a fourth resonance capacitor configured to connect the second connection terminal with the fourth connection terminal.

5. The apparatus set forth in claim 1, wherein the LED lamp power supply unit is a DC/DC converter constant current power circuit.

6. The apparatus set forth in claim 1, wherein the LED lamp power supply unit is a series regulator constant current power circuit.

7. The apparatus set forth in claim 1, wherein the LED lamp power supply unit is a current limiting resistor.
